(19) United States
(12) Patent Application Publication
(10) Pub. No.: US 2005/0012819 A1
(43) Pub. Date: Jan. 20, 2005

(54) Scanning device with sensors and camera or tricorder

(76) Inventor: Michael Francis Niemi, West Jordan, UT (US)

Correspondence Address: MICHAEL NIEMI, 6499 S. Daffodil Way, West Jordan, UT, 84084, US

(21) Appl. No.: 10/621,013

(22) Filed: Jul. 17, 2003

(51) Int. Cl. H04N 9/47

(52) U.S. Cl. 348/148

(57) ABSTRACT

The use of a robotic controller board to manage the influx of data from one or more sensors, and to send that data, in RS232 or serial form, to a Palm OS Computing Device. In this case, a Handspring Prism with a Camera to sense radiation, heat, motion, direction and distance from objects from the Scanning device. The Prism also has an onboard Clock and Palm OS software that can be used, like Notepad, to take notes, etc. to store data about an incident(s) that the Scanner is or had recorded.

The Handheld Scanner or Tricorder, is a combination of devices assembled in a new way to provide security agencies or other offices as a mobile way to record threats or events detrimental to Human life.

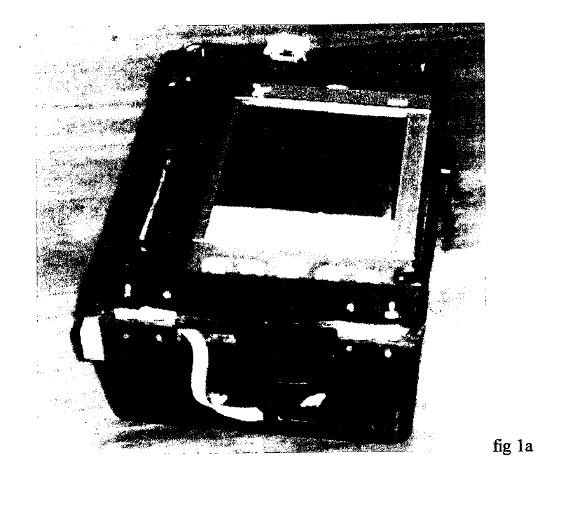

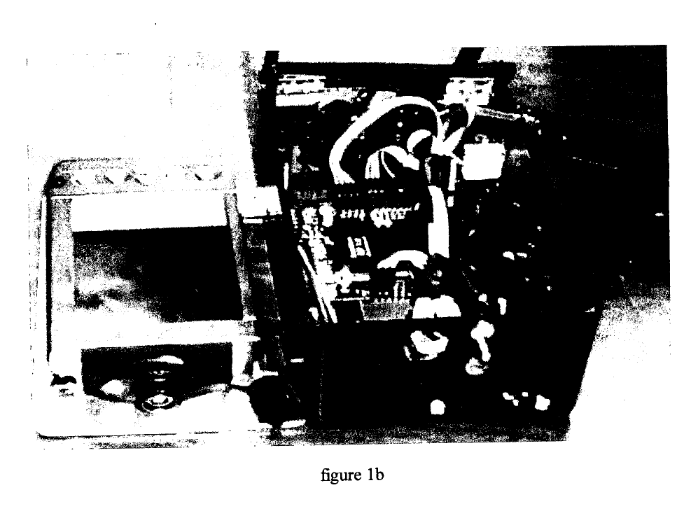

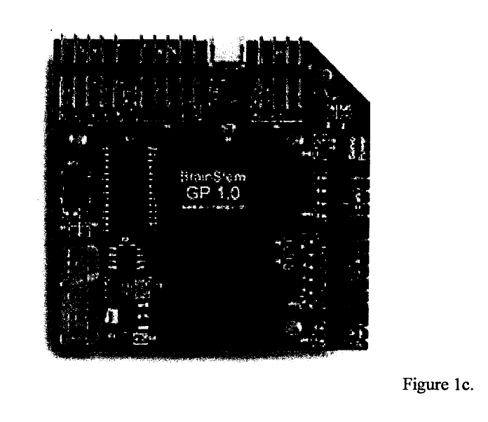

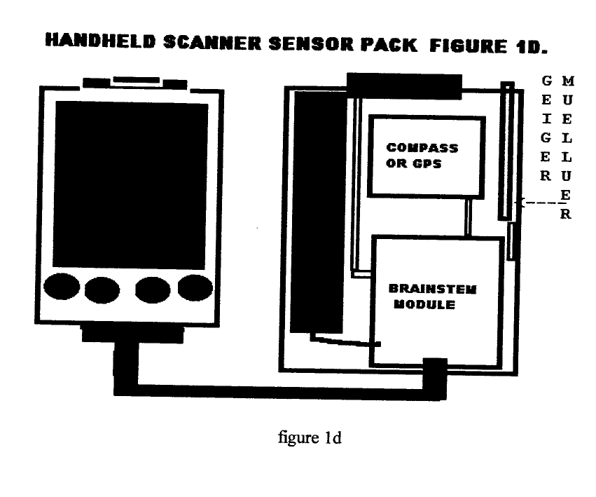

The basic structure of the device is a Palm OS PDA (see FIG. 1a) or Microsoft CE device on top of a sensor pack that can hold sensors (see FIG. 1b) in a separate case that detects Radiation, Heat, UV, Smoke, movement, direction via electronic Compass or GPS device, Mapping, and the ability to use the built in PDA software to record photographs of the scene and take notes.

The sensor pack is controlled by a BrainStem robotic controller that takes in data in from sensors attached to its main three (3) input ports (see FIG. 1c), it can accept raw data from any kind of sensor in Analog, Serial or IIC (I squared C) formats. The Programming (see FIG. 1e) of the Brainstem steps to each sensor in round robin fashion, and storing the sensor data in its memory. On command, it transmits the data to the Palm, where a special program accepts the Data streamed in by an RS232 connection, and alerts the user to threats or events by evaluating the raw data and presenting it on the screen all at one time. If the PDA device can hold a camera, like the EyeModule2 on the Prism pictured in FIG. 1a. The PDA devotes a part of the screen to stream the video constantly. The Camera has a mechanical shutter and the PDA software has a software shutter, where pictures can be taken on the scene, or when another sensor sends a value, the program on the PDA can evaluate it and decide to snap a picture automatically.

The sensor pack (see FIG. 1d) has a number of Sensors. An Electronic Compass that can show direction (N, NE, E, etc), a I.R. Range finder, a distance measuring device, a Heat Sensor that can display any heat source in degrees, a Geiger Mueller Tube that in conjunction with a DC to DC adapter and 300 volt Capacitor, can read Alpha and Gamma radioactive hot spots, a GPS module with GPS mapping software on the PDA to show location, or mapping software for non-GPS equipped Sensors.

The Handheld Scanner is meant to be carried by security personnel by hand. The limits of the sensors can be programmed to alert the User or to trigger some operation automatically. The Handheld Scanner is designed to operate both the PDA and sensor pack from a 9.6 rechargeable Lithium Ion Battery. Because the PDA is attached to the sensor pack, the length of RS232 cable can be quite long. So the sensor pack can be fixed and powered by the rechargeable battery, a vehicle or buildings power supply. If the sensor pack is fixed and power is generated from an electrical outlet, the power limitations and number of sensors is irrelevant, the sensor pack can handle any kind of sensor and does not need to be carried by hand. The PDA can be mounted for the Users convenience and powered by a wall socket, vehicle wiring or by its internal rechargeable battery, making it more useful.

The claims will show how it can be used in detail. The User also has access to all normal Internal PDA software, like the Palm OS Notepad, to take notes at the time of the event. The PDA also has an internal clock and calendar, which can report or log date and time during an Event. The Visors' EyeModule2 Software uses a Time and Date stamp when it records a picture when one of the shutters are pressed, or activated by a software trigger.

I: I claim the device the device, properly powered and equipped, can be used as a portable data recorder and to provide data as an on screen alert, and/or to be saved for analysis after some kind of event or threat has been averted or detected.

II: In relation to claim I, I claim the device can be used, with batteries and the proper sensors, as a personal documentation device in hazardous situations or other conditions, where a hidden radioactive source, smoke, or heat masked by smoke or other material may obscure the danger from the User, where the User would be ordinarily be unaware of the danger nearby.

III: In relation to claim I, I claim that the device can be used to determine the location of the user of the device when properly outfitted with the electronic Compass and software maps, giving the user a bearing, the time, and if equipped with a camera, the means to photograph anything around the user, in case the user is guarding, or gets lost, disoriented, sightseeing, etc.

IV: In relation to claim I, I clam that the device, when properly outfitted with the PDA camera and IR Ranger, can take pictures at any interval, with time and date stamp to record movement via the IR Ranger of a certain object at any preprogrammed distance, as a security device in restricted or sensitive areas, such as an office, a screening room, etc.

IV: In relation to claim I, I clam that the device, when properly outfitted with the PDA camera and IR Ranger, and properly wired to a vehicles internal electrical system, can take pictures automatically of a vehicle too close; or judged by PDA programming of distance vs. speed, to be a hazard of imminent collision with the front and back of the so-equipped vehicle.

VI: In relation to claim I, I clam that the device, when properly outfitted with the Heat Sensor and IR Ranger can visually warn an EMR (emergency first responder person) of danger of a fire or wall or other obstruction when obscured by smoke.
